(19) United States
(12) Patent Application Publication
(10) Pub. No.: US 2016/0113452 A1
(43) Pub. Date: Apr. 28, 2016

(54) SUPPORT CAPABLE OF BEING APPLIED ON SANITARY APPLIANCES AS AN AID TO THE USE THEREOF

(71) Applicant: COMFORTSEAT S.R.L., 21100 Varese (IT)

(72) Inventor: BRUNO TAVELLI, VARESE (IT)

(21) Appl. No.: 14/524,772

(22) Filed: Oct. 27, 2014

(51) Int. Cl. A47K 13/00; F16B 47/00; A47K 13/26

(52) U.S. Cl. CPC A47K 13/005; A47K 13/26; F16B 47/00

(57) ABSTRACT

There is provided a support device 1 capable of being engaged with a sanitary appliance 20 so as to define an aid for using the sanitary appliance 20 itself, particularly suitable for the elderly, disabled and/or infirm. The support device comprises a support body 2 having a rest surface 7 facing upward in conditions of normal use of the device 1 and a lower surface 8 opposite the rest surface 7; the support body 2 is substantially “U”-shaped and has a first substantially rectilinear portion 3, a second substantially rectilinear portion 4 which is parallel to said first portion 3, as well as a curvilinear connecting portion 5 that connects said rectilinear portions 3, 4 to each other. The support device is provided with a plurality of suction cups 6 constrained to the support body 2 on the lower surface 8 thereof and capable of removably engaging said device 1 with said sanitary appliance 20.

The present invention relates to a support device capable of being engaged with a sanitary appliance so as to define an aid for using the sanitary appliance itself. The invention further relates to the associated use of the support device. The invention has application in particular for the correct and easier support of disabled, elderly and infirm people and children on a sanitary appliance, particularly a bidet and/or toilet.

The use of conventional aids for supporting users of sanitary appliances is well known; these aids have the purpose of supporting the user at a greater height than on normal support surfaces of toilets or bidets so as to make the operations of sitting down and getting up from the sanitary appliance easier for users with motor difficulties. The known aids are generally provided with a fold-up body which, when lowered in the operative position, enables the raised support of said users. Said conventional devices are usually used on sanitary appliances of the toilet type and are constrained, in particular by means of one or more fixed hinges, to a sanitary appliance so that they can be folded down by means of a rotation about an axis common to one or more hinges to enable use in a substantially horizontal position or to move the device away from the surface of the sanitary appliance itself, making the device move into a rest position.

In other words, these aids in actual fact consist of a seat of considerably increased dimensions fixedly engaged with the toilet in a conventional manner, that is, like common standard seats (the hinges for moving the seat are obviously adapted to the increased dimensions thereof, but the operation is absolutely the same). Obviously, there are also known sanitary appliances of the toilet type that are not provided with the aforesaid conventional support device and sanitary appliances of the bidet type, which are not usually provided with a support device. However, the conventional devices previously described have some drawbacks and/or operating limits. Such known devices are in fact awkward to use, particularly for disabled, elderly and infirm users and children, who need greater comfort and better accessibility to the sanitary appliance itself. The users mentioned can for example have problems sitting down or moving away from the conventional devices; such problems can be due, for example, to the reduced mobility of the user, but also to an inconvenient accessibility of the conventional support device. In general, in fact, both the toilet and bidet have rather low rest surfaces which oblige the user to bend a great deal while sitting and make sizable efforts while getting up from the sanitary appliance, with the risk of falling and getting injured. A further secondary drawback of the conventional devices is given by the fact that, as they are usually rigid, when they are used they do not deform and therefore do not minimally adapt to the user's anatomy, thus not providing the user with any particular comfort during their use. The conventional devices rigidly constrained to a sanitary appliance, in particular by means of hinges, are also particularly inconvenient because of the fact that they are not removable and therefore their use on one sanitary appliance precludes their subsequent use on another appliance, which may not be provided with such a device. Moreover, once the aid is fixed, it must be used by everyone, including users who do not need it, and for whom it can be inconvenient for other reasons. Not being removable, the aforesaid conventional support devices are additionally of inconvenient accessibility when it comes to sanitizing them, particularly for users with impaired mobility.

The main object of the present invention is to solve one or more of the problems found in the prior art. One object of the present invention is to propose a device capable of being engaged with a sanitary appliance so as to define an aid for using the sanitary appliance itself. It is moreover an object of the present invention to propose a support device, in particular for disabled, elderly and infirm users and children, capable of providing them with greater comfort during use of the sanitary appliance itself. It is a further object of the present invention to provide a removable device, which can be removed from the sanitary appliance in order to be, for example, transported, stored or sanitized. It is a further object of the present invention to improve the comfort of users during use of a sanitary appliance. These objects and still others, which will become more apparent from the following description, are substantially achieved by a support device capable of being engaged with a sanitary appliance so as to define an aid for using the sanitary appliance itself according to what is expressed in one or more of the appended claims.

A detailed description of one or more preferred embodiments of the invention will now be provided by way of non-limiting example, in which:

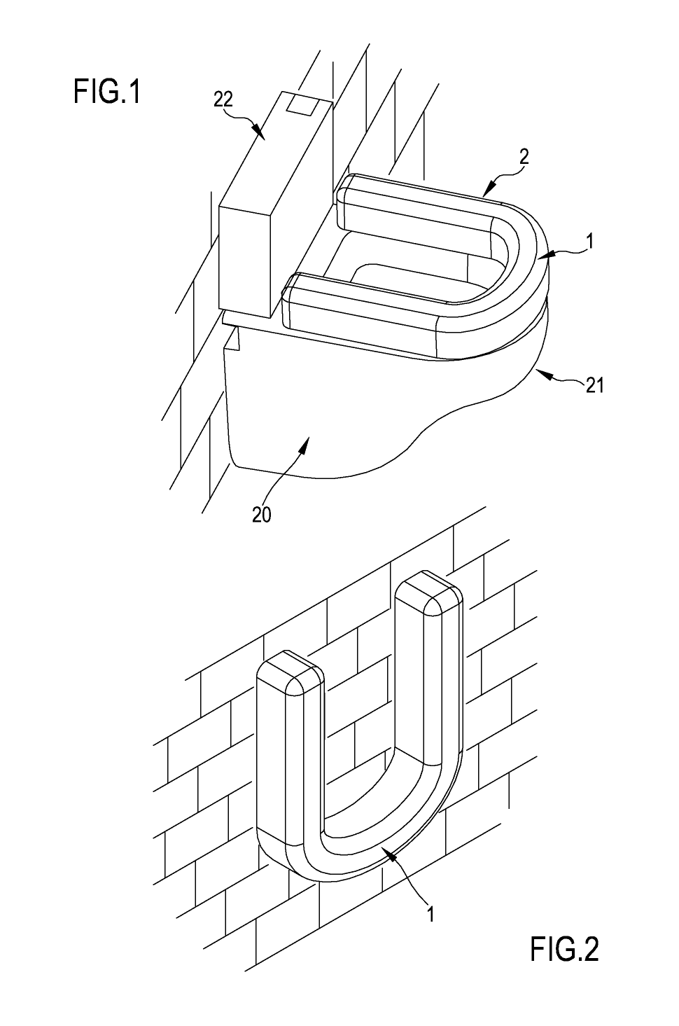

FIG. 1 shows a device in accordance with the present invention engaged on a surface of a sanitary appliance of the toilet type;

FIG. 2 shows a device in accordance with the present invention positioned on the vertical surface of a smooth wall in a condition of non-usage;

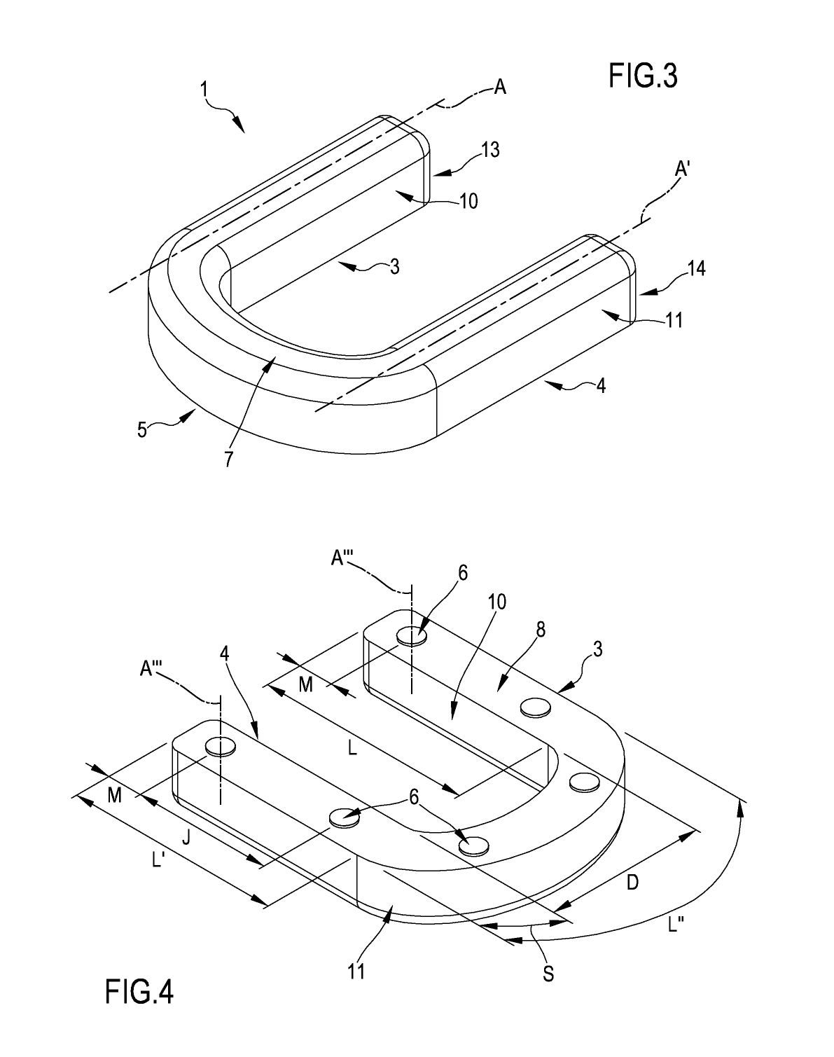

FIG. 3 shows an upper perspective view of a device in accordance with the present invention;

FIG. 4 shows a lower perspective view of a device in accordance with the present invention;

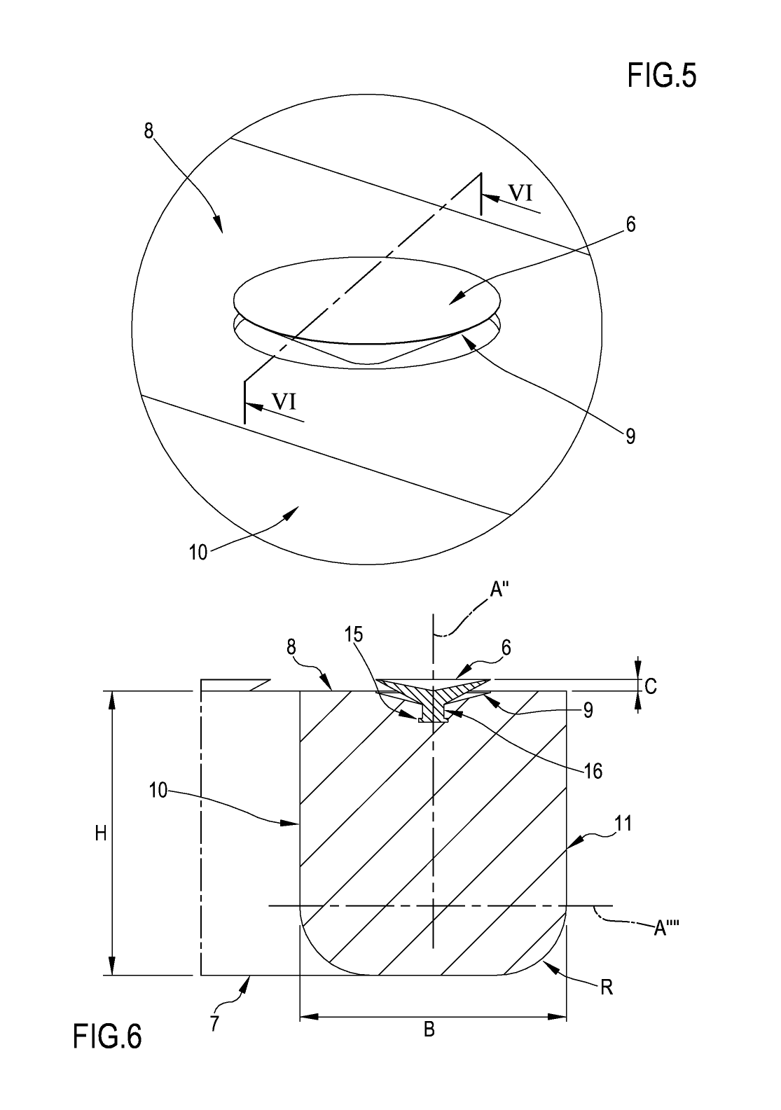

FIG. 5 shows the detail of a suction cup of a device in accordance with the present invention;

FIG. 6 shows a section, derived according to the plane VI-VI shown in FIG. 5, of a device in accordance with the present invention in a first rest position;

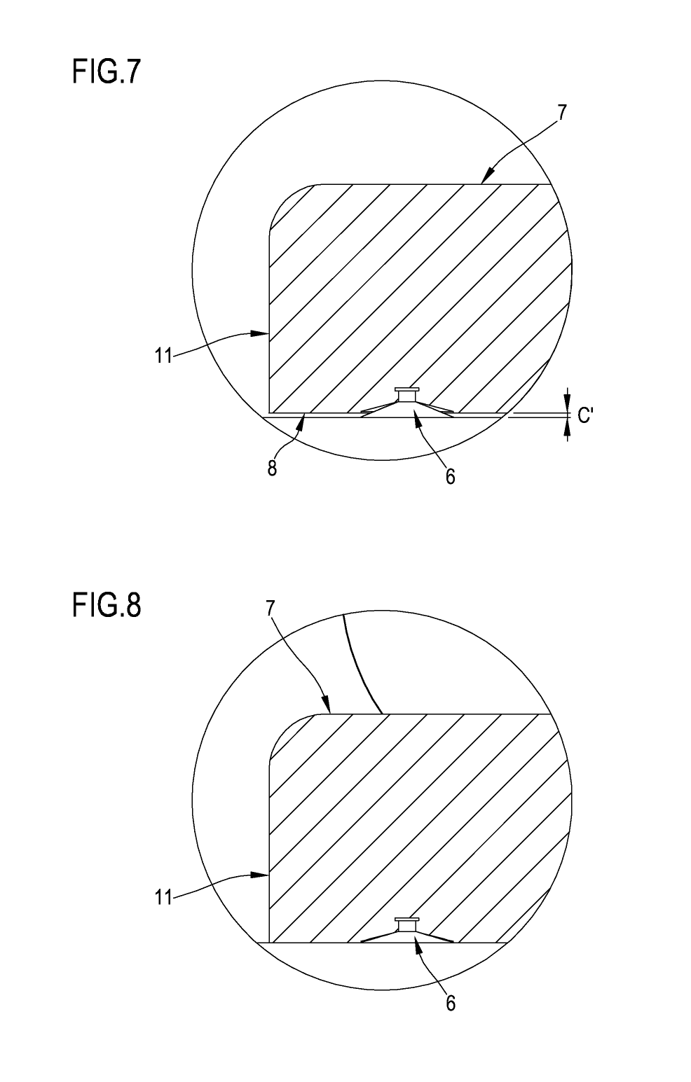

FIG. 7 shows a partial section of a device in accordance with the present invention in which a suction cup can be seen in a second operative position wherein the suction cup emerges away from the lower surface of the support body;

FIG. 8 shows a partial section of a device in accordance with the present invention in which a suction cup can be seen in a second operative position wherein the suction cup is completely housed inside the respective seat thereof;

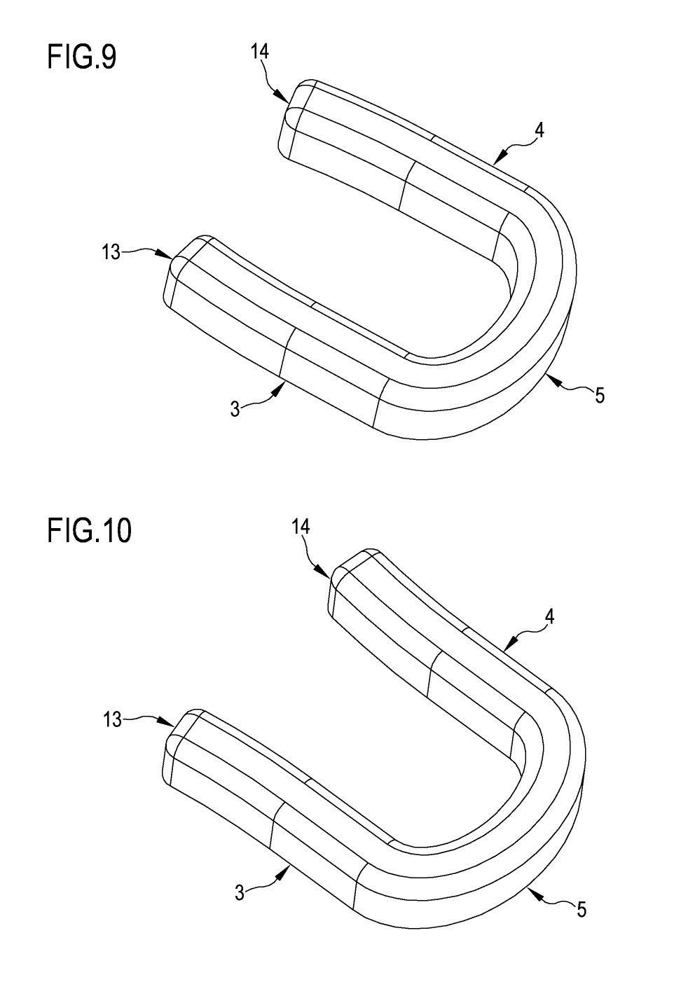

FIG. 9 shows a device in accordance with the present invention in a first deformed configuration;

FIG. 10 shows a device in accordance with the present invention in a second deformed configuration;

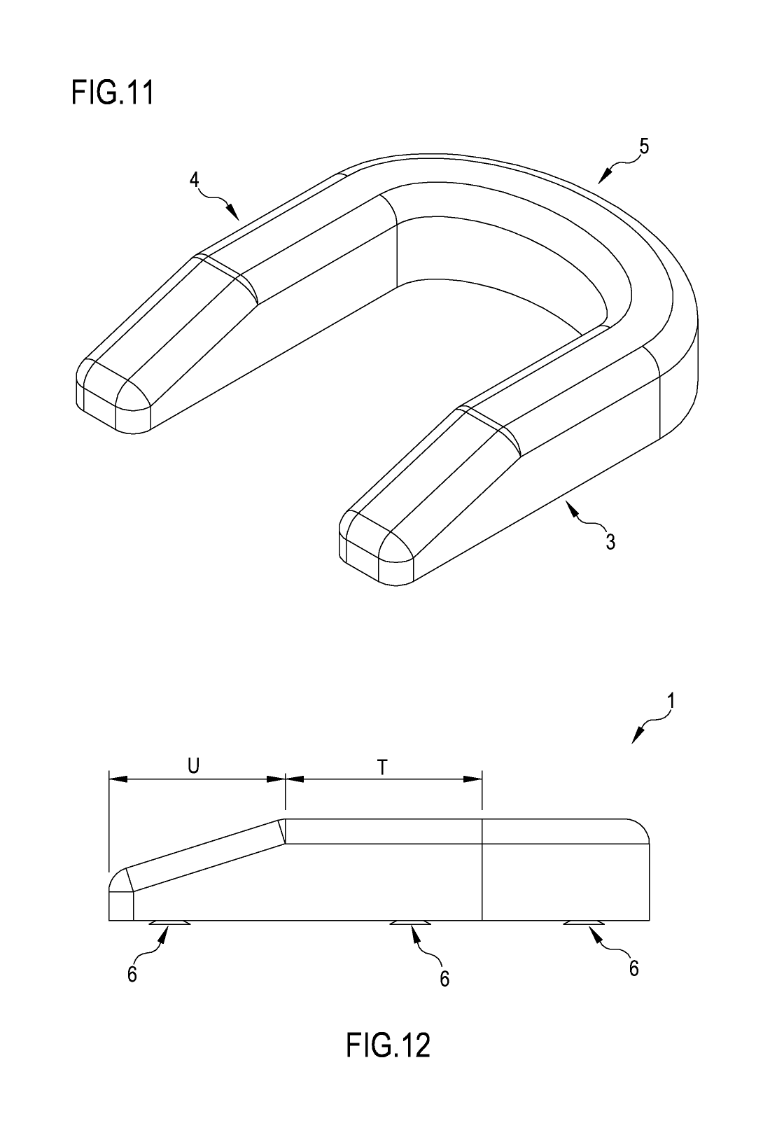

FIG. 11 shows a device in accordance with a further embodiment of the present invention;

FIG. 12 shows a side view of the device of FIG. 11.

With reference to the figures, 1 denotes overall a support device for a sanitary appliance 20 such as a toilet or bidet serving to define an aid for using the sanitary appliance 20 itself. The device comprises at least a support body 2, which is in turn endowed with a first rectilinear portion 3 and a second rectilinear portion 4 which are reciprocally parallel. The support body 2 further comprises a curvilinear connecting portion 5, which connects the first rectilinear portion 3 and the second rectilinear portion 2 to each other, and at least one suction cup for removably engaging the device 1 with the sanitary appliance 20. Preferably, the portion 3, the portion 4 and the connecting portion 5 are made in one piece so that the support body 2 has an upper rest surface 7 facing upward in conditions of normal use of the device and a lower surface 8 opposite the rest surface. The rest surface 7 is configured to be a rest and support for the user during use of the sanitary appliance 20 itself and is in fact defined by the upper surface 7 of the first portion 3, the second portion 4 and the connecting portion 5. The lower surface 8 opposite the rest surface 7 in turn comprises the lower surface 8 of the first portion 3, the second portion 4 and the connecting portion 5. The suction cups 6 are constrained to the support body on the lower surface 8 thereof. Preferably, the device 1 comprises at least one seat 9 and in particular two housing seats 9 on the lower surface 8 of said support body 2; the housing seats 9 are suitable for receiving and at least partially housing the suction cups 6, which are engaged with the support body 2 in such a way as not to allow the suction cup 6 to come out of its respective seat 9. The engagement of the suction cup with the support body 2 is obtained, for example, by means of an undercut 15, which prevents the portion internal to the body of the suction cup from leaving the seat. In the embodiment shown, the support device 1 comprises a plurality of housing seats 9, in particular at least a housing seat 9 for each of the suction cups 6. Under the various conditions of use of the support device 1, the suction cups 6 can assume at least a first rest position, illustrated in FIG. 6, in which they emerge away from the lower surface 8 of the support body 2 by a first distance C and at least a second operative position, illustrated in FIGS. 7 and 8, in which the suction cups 6 are at least partially housed within the respective housing seats 9. In the second operative position, the suction cups 6 can be completely housed within the respective seats 9, as can be seen in FIG. 8, or emerge away from the lower surface 8 of the support body 2, as shown in FIG. 7, by a second distance C′ that is smaller than the first distance C assumed in the first rest position. In other words, in the rest condition of the aid, the suction cups 6 project by a certain distance therefrom; when the aid is engaged with the appliance, the suction cups 6 can still project by a certain distance from the seat 9, but this distance is less than the previous one due to the weight of the support body 2, which pushes on the suction cups 6, and due to the fact that the head of the suction cups engages the upper surface of the sanitary appliance and is in an operative condition, pressed down on and coupled with that surface. In a third condition, illustrated in FIG. 8, in which the user is resting on the aid, the suction cups 6 are pressed further into the seats 9 also by the weight of the user. In this condition, the suction cups 6 are completely housed within the seats 9 and the lower surface 8 of the support body 2, which is in particular flat, mates perfectly with the upper surface, which is in particular flat, of the sanitary appliance, thereby ensuring optimal stability of the aid. Going back to the structural description of the device, at least one between the two rectilinear portions 3, 4 and the connecting portion 5 can be made at least partially, in particular completely, of deformable material, preferably elastically deformable material. The elastically deformable material allows the support body 2 to become deformed under the action of a user's weight during use of the support device 1 and later go back to assume a non-deformed configuration following use of the support device 1 by a user. In general, at least one between the two rectilinear portions 3, 4 and the curvilinear connecting portion 5 can be made, at least partially, in particular completely, of plastic material. Preferably, at least one between the two substantially rectilinear portions 3, 4 and the at least partially curvilinear connecting portion 5 can be made, at least partially, in particular completely, of polyurethane. The preferred embodiment envisages that the entire support body 2 be made of elastically deformable material, in particular it envisages that the same support body 2 be made of a plastic material such as polyurethane. The first portion 3, the second portion 4 and the connecting portion 5, have an outer lateral surface 11 and an inner lateral surface 10, geometrically conformed in such a way as to define a substantially “U” shape. The first substantially rectilinear portion 3 extends along a first longitudinal axis A for a first length L and the second substantially rectilinear portion 4 extends along a second longitudinal axis A′ for a second length L′; the second longitudinal axis A′ is in particular parallel to the first longitudinal axis A, at least in a first non-deformed configuration of the support device 1. The first length L is not smaller than the second length L′; in particular it is of the same order of magnitude as the second length L′, and in even greater detail it is equal to the second length L′ so that the rectilinear portions 4 extend for the same length. From a dimensional viewpoint, the length L′ is optionally no less than fifteen centimeters, in particular no less than twenty centimeters. The first portion 3 is spaced apart from the second portion 4 by a length D calculated as the distance between the inner lateral surface 10 of the first portion 3 and the inner lateral surface 10 of the second portion 4; the length D is preferably no less than ten centimeters, in particular no less than 15 cm. Each of said portions 3, 4 can have two ends; at least one end of one of the two portions 3, 4 is connected to the respective end of the other portion 4, 3 by means of the curvilinear connecting portion 5, in such a way as to make the support body 2 take on a substantially “U” shape. The other two ends are free; the first portion 3 and the second portion 4 have the free end 13 and the free end 14, respectively. The suction cups 6 positioned on the lower surface 8 of the first substantially rectilinear portion 3 of said support body 2 and the suction cups 6 positioned on the lower surface 8 of the second substantially rectilinear portion 4 of said support body 2 can moreover be located at a same distance M from the respective free ends 13, 14. In this manner, the support body 2 will have a removable constraint system (suction cups) which is symmetrical and consequently more balanced during use. Moreover, the suction cups 6 positioned on the lower surface 8 of said support body 2 can be spaced apart from at least a consecutive suction cup 6 by a same distance J. Preferably, the at least partially curvilinear connecting portion 5 extends preferentially along a curvilinear abscissa S for a third length L″, said third length L″ being determined with reference to the perimeter defined by the extent of the outer lateral surface 11 along the at least partially curvilinear connecting portion 5. The curvilinear abscissa S can be characterized by a variable radius of curvature which can vary according to any law. For example, the curvilinear abscissa S can have a constant radius of curvature.

The rectilinear portion 3, the rectilinear portion 4 and the connecting portion 5 respectively have cross-section profiles P, P′, P″, which can be characterized by the same geometrical shape or by geometrical shapes differing from one another and in particular variable also within the same portion. The profiles P, P′, P″ respectively have a height H, H′, H″ and a base B, B′, B″, which can be constant or vary along the length of the respective portion L, L′, L″. The heights H, H′, H″ can also vary along a horizontal axis A″″ parallel to the respective bases B, B′, B″, which can also vary along a vertical axis A″ parallel to the respective heights H, H′, H″. The specific embodiment illustrated shows cross-section profiles that are substantially identical along the entire extent of the support body 2. In an alternative embodiment of the invention, illustrated in FIG. 11 and in FIG. 12, the heights H, H′ associated with the respective substantially rectilinear portions are constant for a length T, and then vary for a length U; the lengths T and U are substantially parallel to the axes of extension A, A′ of the portions 3,4. The heights H, H′ can vary according to any law of variation, in particular they can vary linearly. Preferably, the first portion 3 and the second portion 4 are made of deformable material, preferably elastically deformable material. The deformability of the material enables the free ends 13, 14, respectively, of said two substantially rectilinear portions 3, 4 to adapt to a plurality of shapes of the surface of said sanitary appliance 20. A first deformed configuration and a second deformed configuration of the support device 1 can be seen, for example, in FIG. 9 and in FIG. 10, respectively; in particular, in the first deformed configuration, both of the substantially rectilinear portions 3, 4 have been deformed in such a way as to bring the respective free ends 13, 14 nearer together. In the second deformed configuration, the two substantially rectilinear portions 3, 4 have instead been deformed in such a way as to spread the respective free ends 13, 14 further apart. The present invention further relates to a use of the support device 1. In particular, the present invention relates to a use of the support device 1 for engaging with an at least partially flat surface of a sanitary appliance 20. During use, the support device 1 engages the sanitary appliance in such a way that the curvilinear connecting portion 5 is constrained to the front portion 21 of the sanitary appliance 20; the term engages means that the support device 1 can be attached to (if provided with suction cups) or rested upon (if the suction cups are only on the rectilinear portions) the front portion 21 of the sanitary appliance 20, whilst front portion 21 means the portion of the sanitary appliance 20 opposite a device 22 for dispensing water. The present invention makes it possible to obtain at least one or more of the following advantages and to solve one or more of the problems encountered in the prior art. First of all, the invention enables a user with physical problems to make use of sanitary appliances more conveniently by providing an easily removable reusable aid which permits the use surfaces of a bidet or toilet to be raised so as to make approaching and moving away from the sanitary appliance easier. The invention is convenient to use and easy to implement, providing a support which, if made from deformable material, is capable of adapting to the anatomy of the user who uses it and/or to the shape of the sanitary appliance itself. Being removable from the sanitary appliance, the support device according to the present invention is moreover transportable, enabling the use thereof on more than one sanitary appliance. Thanks to the suction cups positioned on the lower surface of said support device, when it is not used, it has the advantage of being able to be placed elsewhere, rather than on the surface of the sanitary appliance it is usually used on. A device according to the present invention can be placed, for example, on the vertical surface of a smooth wall, such as a tiled bathroom wall. Finally, the invention is simple and economical to produce, since it consists exclusively of a single body of plastic material which can be obtained by molding in a conventional manner and a plurality of suction cups at least partially embedded in the main body.

1. A support device configured to be engaged with a sanitary appliance so as to define an aid for using the sanitary appliance itself, said device comprising at least:
a support body having a rest surface facing upward in conditions of normal use of the device, a lower surface opposite the rest surface, the support body comprising:
a first substantially rectilinear portion;
a second substantially rectilinear portion, said second substantially rectilinear portion being substantially parallel to said first substantially rectilinear portion;
an at least partially curvilinear connecting portion which connects said substantially rectilinear portions to each other; and
at least two suction cups constrained to the support body on the lower surface thereof and capable of removably engaging said device with said sanitary appliance.

2. The device according to claim 1, comprising at least two housing seats on the lower surface of said support body, each configured to receive a respective one of said suction cups, said suction cups being capable of assuming at least a first rest position in which said suction cups emerge away from the lower surface of the support body by a first distance and at least one second operative position in which said suction cups are at least partially housed within said housing seats, in said second operative position said suction cups being completely housed within said seats or emerging away from the lower surface of the support body by a second distance that is smaller than the first distance assumed in the first rest position.

3. The device according to claim 1, wherein at least one between said two reciprocally parallel rectilinear portions and said at least partially curvilinear connecting portion is made of elastically deformable plastic material.

4. The device according to claim 1, wherein said reciprocally parallel rectilinear portions and said at least partially curvilinear connecting portion are made in one piece, said first substantially rectilinear portion extending along a first axis for a first length, said second substantially rectilinear portion extending along a second axis substantially parallel to said first axis for a second length, said first substantially rectilinear portion being spaced apart from said second substantially rectilinear portion by a length, each of said substantially rectilinear portions having respectively two ends, at least one end of the two substantially rectilinear portions being connected to the respective end of the other substantially rectilinear portion by means of said at least partially curvilinear connecting portion in such a way as to make the support take on a substantially “U” shape, the other two ends not connected to each other being free ends, said free end belonging to said first substantially rectilinear portion, said free end belonging to said second substantially rectilinear portion, said length being no less than 15 cm, and wherein said first length is of the same order of magnitude as said second length.

5. The device according to the preceding claim, wherein said first length is equal to said second length and is no less than 20 cm.

6. The device according to claim 1, wherein said at least partially curvilinear connecting portion extends for a third length along a curvilinear abscissa with a radius of curvature that is variable according to a specific law of variation.

7. The device according to claim 1, wherein said first and said second substantially rectilinear portions are characterized, in cross section, by a first profile, the upper surface of said first profile being spaced apart from the lower flat surface of said first profile by a height, said first profile being further delimited by a substantially flat outer lateral surface and by a substantially flat inner lateral surface, said two lateral surfaces, being reciprocally spaced apart by a distance, wherein said height is variable in accordance with a specific law of variation along the preferential axis of extension of said first substantially rectilinear portion and/or along a horizontal axis parallel to said distance and wherein said distance is substantially constant along the preferential axis of extension of said first substantially rectilinear portion and/or along a vertical axis parallel to said height.

8. The device according to the preceding claim, wherein said distance has dimensions of the same order of magnitude as said height when referred to the same cross section.

9. The device according to claim 1, wherein said at least partially curvilinear connecting portion is characterized by a further profile, the upper surface of said further profile being spaced apart from the flat lower surface of said further profile by a height, said further profile being characterized by an outer lateral surface and an inner lateral surface, said two lateral surfaces, being reciprocally spaced apart by a distance, wherein said height is substantially constant along the curvilinear abscissa of extension of said at least partially curvilinear connecting portion and wherein said distance is substantially constant along the preferential curvilinear abscissa of extension of said at least partially curvilinear connecting portion and/or along a vertical axis parallel to said height.

10. The device according to claim 7, wherein the upper surface is connected to at least one between the outer and inner lateral surfaces by means of at least one curvilinear connection in at least one section of at least one between said first substantially rectilinear portion, said second substantially rectilinear portion and said at least partially curvilinear connecting portion.

11. The device according to claim 1, having:
at least one suction cup constrained to the support body on the lower surface of said first substantially rectilinear portion;
at least one suction cup constrained to the support body on the lower surface of said second substantially rectilinear portion; and
at least one suction cup constrained to the support body on the lower surface of said connecting portion.

12. The device according to claim 1, wherein said device has at least two suction cups on the lower surface of the first substantially rectilinear portion, at least two suction cups on the lower surface of the second substantially rectilinear portion and at least two suction cups on the lower surface of the substantially curvilinear connecting portion.

13. The device according to claim 1, wherein said suction cups positioned on the lower surface of the first substantially rectilinear portion of said support body and said suction cups positioned on the lower surface of the second substantially rectilinear portion of said support body are located at a same distance other than zero from their respective free ends.

14. The device according to claim 1, wherein each of said suction cups is positioned in an internal median area of the lower surface of the first and second rectilinear portions and of the connecting portion distanced from a perimeter of the lower surface.

15. The device according to claim 1, wherein the first and second rectilinear portions and the connecting portion exhibit a profile in a cross section transverse to the preferential axes of extension that is substantially constant along an entire extent of the support body.

16. A support device comprising a support body having a substantially “U” shape and featuring:
a first substantially rectilinear portion;
a second substantially rectilinear portion, said second substantially rectilinear portion being substantially parallel to said first substantially rectilinear portion;
an at least partially curvilinear connecting portion which connects said substantially rectilinear portions to each other; said first and second substantially rectilinear portions and said connecting portion having:
a rest surface facing upward in conditions of normal use of the device,
a lower surface opposite the rest surface;
a plurality of suction cups non-removably constrained to the support body on the lower surface thereof;
a plurality of housing seats on the lower surface of said support body, each suitable for receiving at least one of said suction cups, said suction cups being capable of assuming at least a first rest position in which said suction cups emerge away from the lower surface of the support body by a first distance and at least one second operative position in which said suction cups are at least partially housed within said housing seats, in said second operative position said suction cups being completely housed within said seats or emerging away from the lower surface of the support body by a second distance that is smaller than the first distance assumed in the first rest position, the support device further comprising a sanitary appliance having an at least partially flat annular mating surface, the substantially “U”-shaped support body being removably engaged with the sanitary appliance so as to define an aid for using the same sanitary appliance, the suction cups being removably engaged with the mating annular surface and the rest surface of the support body defining a seat for the user of the sanitary appliance which is raised relative to the mating surface.

17. A use of a support device comprising at least:
a support body having a rest surface facing upward in conditions of normal use of the device, a lower surface opposite the rest surface, the support body comprising:
a first substantially rectilinear portion;
a second substantially rectilinear portion, said second substantially rectilinear portion being substantially parallel to said first substantially rectilinear portion;
an at least partially curvilinear connecting portion which connects said substantially rectilinear portions to each other; and
at least one suction cup and in particular two suction cups constrained to the support body on the lower surface thereof and capable of removably engaging said device with said sanitary appliance,
to engage with an at least partially flat surface of a sanitary appliance so as to define an aid for using the sanitary appliance itself.

18. The use according to claim 17, wherein said sanitary appliance comprises a water dispensing device, and the at least partially curvilinear connecting portion is engaged with a front portion of said sanitary appliance, said front portion being opposite the water dispensing device.
